(19) United States
(12) Patent Application Publication
(10) Pub. No.: US 2023/0385382 A1
(43) Pub. Date: Nov. 30, 2023

(54) BOUNDED INCREMENTAL CLUSTERING

(71) Applicant: ADOBE INC., San Jose, CA (US)

(72) Inventors: Vaibhav Jain, Noida (IN); Dhruv, Rohtak (IN); Damanjit Singh, Noida (IN)

(21) Appl. No.: 17/827,371

(22) Filed: May 27, 2022

(51) Int. Cl. G06K 9/62; G06F 16/906

(52) U.S. Cl. CPC G06K 9/6219; G06F 16/906; G06K 9/6222

(57) ABSTRACT

A clustering system provides bounded incremental clustering for adding input data instances to existing data clusters. Input data instances are received and processed to form input data clusters. For a given input data cluster, a subset of existing data clusters is selected, and a subset of existing data instances are selected from each of the selected existing data clusters. The selected existing data instances and the input data instances from the given input data cluster are processed to form intermediate clusters. At least one intermediate cluster is mapped to an existing data cluster.

### BACKGROUND

Data clustering techniques can be utilized to organize and group electronic data such that data instances in the same group are more similar to each other than data instances in other groups with respect to their properties and attributes. Data clustering can be immensely useful in a variety of electronic data tasks. For instance, search and retrieval of data is a complex problem that can be facilitated by data clustering. This is especially the case for large datasets and/or when dealing with high-dimensional data. High-dimensional data includes information that can be represented by a large number of features or attributes, such as images, video, and audio data. Data clustering can organize the data to facilitate more efficient retrieval. However, clustering data can be a time- and computationally-expensive process, which can be a disadvantage when new data is regularly generated, such as, for instance, when new images are added to an image set. Therefore, complex and non-trivial issues associated with data organization remain due to the limitations of existing techniques.

### SUMMARY

Embodiments of the present technology relate to, among other things, a clustering system that provides for incremental clustering of new data (i.e., input data instances) with existing data that has already been clustered (i.e., existing data instances in existing data clusters) in a bounded manner to control compute time and resource consumption. In accordance with aspects of the technology described herein, input data instances for clustering with existing data clusters are received. Clustering is performed on the input data instances to form input data clusters. Each input data cluster is then processed to cluster the input data instances with the existing data instances. For a given input data cluster, a subset of the existing data clusters are selected based on similarity to the input data cluster. Additionally, existing data instances are sampled from the selected existing data instances. Clustering is performed on the input data instances from the input data cluster and the sampled existing data instances to form intermediate clusters. The intermediate clusters are mapped to existing data clusters, where appropriate, based on similarity between the intermediate clusters and the existing data clusters. In some instances, intermediate clusters are not sufficiently similar to an existing data cluster. In those instances, new clusters are added based on the input data instances of the intermediate clusters.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram showing an example of input data instances to be cluster with a cluster dataset of existing data clusters with existing data instances in accordance with some implementations of the present disclosure;

FIG. 3 is diagram showing an example of clustering input data instances to produce input data clusters in accordance with some implementations of the present disclosure;

FIG. 4 is a diagram showing an example of selecting a subset of existing data clusters for input data clusters in accordance with some implementations of the present disclosure;

FIG. 5 is a diagram showing an example of sampling existing data instances from a selected subset of existing data clusters in accordance with some implementations of the present disclosure;

FIG. 6 is a diagram showing an example of clustering input data instances with sampled existing data instances to produce intermediate clusters and mapping the intermediate clusters with existing data clusters in accordance with some implementations of the present disclosure;

FIG. 7 is a flow diagram showing a method for bounded incremental clustering of input data instances with existing data clusters of a cluster dataset in accordance with some implementations of the present disclosure; and

FIG. 8 is a block diagram of an exemplary computing environment suitable for use in implementations of the present disclosure.

### DETAILED DESCRIPTION

### Overview

Data clustering techniques have a wide range of applications for processing digital data. Among other things, data clustering techniques can facilitate search and retrieval of digital data from storage. For instance, in the field of digital imaging, data clustering can be used to categorize images according to objects in those images. For example, within a group of images of people, the images can be categorized according to the faces of the people so that the images can be quickly referenced and located. Several existing techniques can be used for clustering and categorizing digital images and data in general.

Conventional data clustering techniques can be time- and computationally-expensive to perform every time new data instances are added to an existing dataset. For instance, a brute force solution to adding new data instances to an existing dataset is to re-cluster all existing data instances with the new data instances to get a new set of clusters. However, brute-force clustering is often not practical for use in a production environment having large datasets where new data instances are regularly added because the time and computational power needed to re-cluster all the existing data instances with the new data instances becomes ever increasing. One way to reduce the computational load of data clustering is to incrementally cluster newly added data instances into existing clusters. Even so, it remains difficult to incrementally cluster new data instances into a large number of existing clusters efficiently using existing techniques.

Incremental hierarchical agglomerative clustering (HAC) is one attempt to address these shortcomings of existing clustering techniques. However, incremental HAC still presents drawbacks. For instance, clustering using incremental HAC is not bounded. When the existing dataset is large, the number samples taken from the dataset to perform clustering is likewise large. This results in unbounded compute time and resource consumption, making it inadequate for clustering large datasets.

Embodiments of the present technology solve these problems by providing a clustering system that enables bounded incremental clustering of data instances with existing clusters. Aspects of the technology provide for input data instances to be incrementally clustered with existing clusters in a manner that provides for bounded compute time and resource consumption.

In accordance with some aspects of the technology described herein, input data instances are received for clustering with existing data instances that have already been clustered in existing data clusters of a cluster dataset. Clustering of the input data instances is performed to form input data clusters. Each input data cluster is then processed to cluster the input data instances with the existing data clusters.

For a given input data cluster, a subset of the existing data clusters that are most similar to the input data cluster are selected. Similarity can be based on, for instance, a distance measure between a representation of the input data cluster and a representation of each of the existing data clusters. Additionally, a subset of existing data instances is sampled from each of the selected existing data instances. Clustering is performed on the input data instances of the given input data cluster and the selected existing data instances to form intermediate clusters. The intermediate clusters are then mapped to existing data clusters of the cluster dataset, where appropriate. An intermediate cluster is mapped to an existing data cluster based on similarity, which can be based on, for instance, a distance measure between a representation of the intermediate cluster and a representation of the existing data cluster, or based on a number or proportion of existing data clusters in the intermediate cluster that belong to the existing data cluster.

In some instances, an intermediate cluster is not mapped to an existing data cluster. This can occur, for instance, when the intermediate cluster is not sufficiently similar to an existing data cluster. In some configurations, the intermediate cluster is added to the cluster dataset as a new cluster. In other configurations, clustering is performed on input data instances from unmapped intermediate clusters to form new clusters, and the new clusters are added to the cluster dataset.

The technology described herein provides a number of advantages over existing approaches. For instance, aspects of the technology described herein allow for incremental addition of new data to existing clusters. In this manner, it is not necessary to re-cluster all existing data when new data is generated, and new data can be added to existing clusters more quickly and at lower computational expense as compared to existing clustering techniques. Additionally, aspects provide for bounded clustering as each clustering run is limited to a finite number of existing data clusters selected from a cluster data set and a finite number of existing data instances selected from those existing data clusters. The results from the technology described herein are functionally equivalent to conventional clustering, improving with each run, as new data is added. Thus, this technology is very well suited for flowing data, where the objective is to cluster the in flowing data on a continuous basis in a time and resource bounded manner. Moreover, whereas conventional clustering techniques are unbounded, the technology described herein provides for bounded clustering runs. As a results, the technology reduces the clustering time, compute, and memory required significantly in comparison to conventional clustering techniques, including incremental agglomerative clustering. For instance, if the number of data instances to be clustered is represented by n and the number of clusters is represented by k, then the time complexity of incremental agglomerative clustering is O(k*n²) and space complexity is 0(n²). For incremental agglomerative clustering, n is dependent on existing clustered data, and can be unbounded for large amounts of data. In contrast, while the technology described herein can include multiple cluster runs, for each run, n is finite and bounded and is at most the new data to cluster. Hence, the technology described herein provides significant gains on compute time and memory resources.

### Example System for Bounded Incremental Clustering

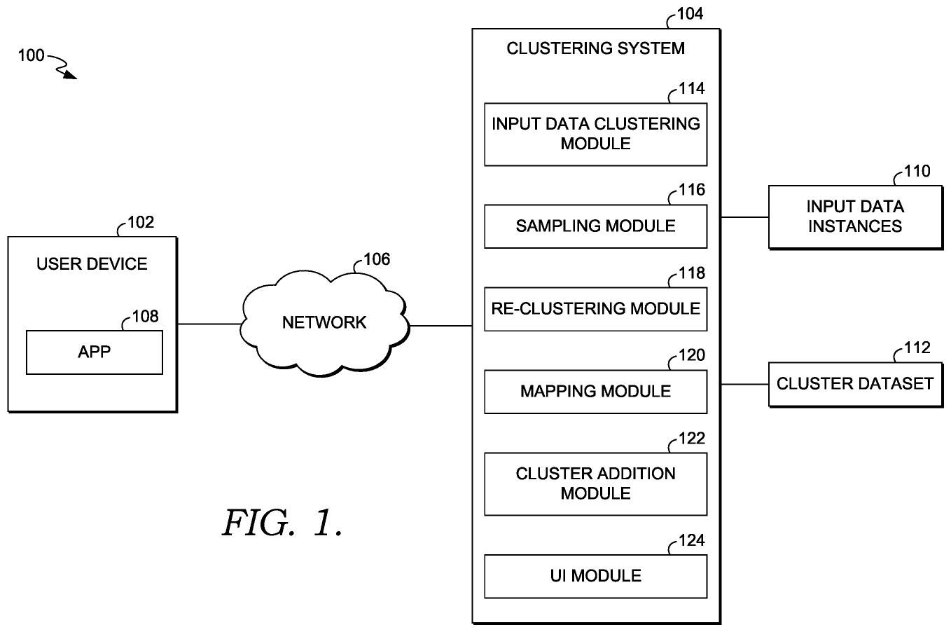

With reference now to the drawings, FIG. 1 is a block diagram illustrating an exemplary system 100 for bounded incremental clustering of data instances in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

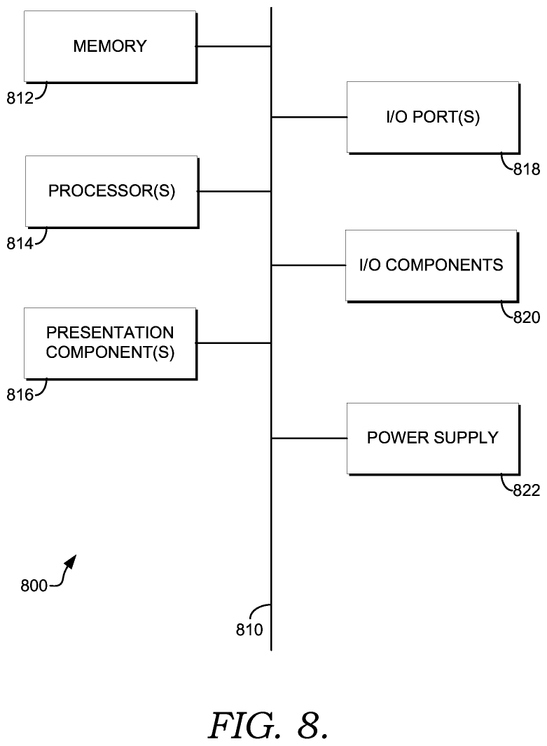

The system 100 is an example of a suitable architecture for implementing certain aspects of the present disclosure. Among other components not shown, the system 100 includes a user device 102 and clustering system 104. Each of the user device 102 and clustering system 104 shown in FIG. 1 can comprise one or more computer devices, such as the computing device 800 of FIG. 8, discussed below. As shown in FIG. 1, the user device 102 and the clustering system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and clustering systems can be employed within the system 100 within the scope of the present technology. Each can comprise a single device or multiple devices cooperating in a distributed environment. For instance, the clustering system 104 could be provided by multiple server devices collectively providing the functionality of the clustering system 104 as described herein. Additionally, other components not shown can also be included within the network environment.

At a high level, the clustering system 104 operates on input data instances 110 and a cluster dataset 112 of existing data clusters to add the input data instances 110 to the cluster dataset 112. The existing data clusters of the cluster dataset 112 comprise clusters formed from existing data instances. Any of a variety of different clustering algorithms can be employed to form the existing data clusters, such as for instance, HAC or mean shift clustering. Each data instance (including each input data instance from the input data instances 110 and each existing data instance from the existing data clusters of the cluster dataset 112) comprises any type of data object or collection of data. For instance, each data instance can comprise image data, audio data, video data, document data, or any other type of data that can be clustered. For purposes of explanation, digital image processing is used as an example application of the disclosed techniques. However, the disclosed techniques are not limited to image processing, and can be used in any suitable application context on any suitable type of data set (e.g., audio data, video data, seismic data, statistical data, etc.). In some cases, each data instance can be a representation of underlying data. For instance, each data instance can comprise a vector, a fingerprint, a hash, a neural network embedding, or other representation formed from underlying data, such as an image.

As shown in FIG. 1, the clustering system 104 includes an input data clustering module 114, a sampling module 116, a re-clustering module 118, a mapping module 120, and a cluster addition module 122. These components can be in addition to other components that provide further additional functions beyond the features described herein. The clustering system 104 can be implemented using one or more server devices, one or more platforms with corresponding application programming interfaces, cloud infrastructure, and the like. While the clustering system 104 is shown separate from the user device 102 in the configuration of FIG. 1, it should be understood that in other configurations, some or all of the functions of the clustering system 104 can be provided on the user device 102. For instance, while FIG. 1 shows a networked environment, some configurations can implement all functions locally on the user device 102.

The input data clustering module 114 clusters the input data instances 110 into a number of input data clusters. The input data clustering module 114 can use any of a variety of different clustering algorithms. By way of example only and not limitation, the input data cluster module 114 can use HAC or mean shift clustering. The clustering algorithm can form clusters based on similarity determined between input data instances. The similarity can be determined, for instance, using a distance function that indicates a distance between two data instances in a given space (e.g., a vector space). By way of example only and not limitation, similarity can be determined using Euclidian distance, cosine distance, Hamming distance, or other distance measure. Data instances that are relatively close to each other (in terms of the distance between the data instances) are more similar than data instances that are relatively far away from each other.

The clustering algorithm of the input data clustering module 114 can employ a similarity threshold when forming clusters. A similarity threshold used for clustering represents a lower limit of similarity between data instances for the data instances to be clustered together. In some configurations, the clustering algorithm used by the input data clustering module 114 employs the same similarity threshold as that employed by the clustering algorithm used to cluster the existing data instances in the existing data clusters of the cluster dataset 112. In other configurations, the clustering algorithm used by the input data clustering module 114 employs a higher similarity threshold than the similarity threshold employed by the clustering algorithm used to cluster the existing data instances in the existing data clusters of the cluster dataset 112. Using a higher similarity threshold causes the input data instances to be more tightly clustered—i.e., input data instances have a higher level of similarity to be included in the same input data cluster.

For each of the input data clusters generated by the input data clustering module 114, the sampling module 116 samples existing data clusters from the cluster dataset 112 to facilitate the process of clustering the input data instances 110 with existing data instances in the cluster dataset 112. For a given input data cluster, the sampling module 116 selects a finite number of existing data clusters that are closest to the given input data cluster. Limiting the selected existing data clusters to a finite number ensures that the clustering is bounded. For instance, the sampling module 116 can select 20 existing data clusters that are closest to the input data cluster. It should be understood that the number of existing data clusters selected by the sampling module 116 for a given input data cluster can be configurable and can be selected based on, for instance, the overall number of the existing data instances, existing data clusters, input data instances, and/or input data clusters.

The sampling module 116 can use any of a variety of different techniques for determining the distance between a given input data cluster and existing data clusters when selecting the existing data clusters for that input data cluster. In some configurations, the sampling module 116 can determine the distance between the given input data instance and each existing data cluster based on the average distance between data instances from each cluster. This can include computing an average representational value from input data instances for the input data cluster, as well as an average representational value from existing data instances for each existing data cluster. The existing data clusters having an average representational value closest (e.g., using simple similarity match) to the average representational value for the input data cluster are selected. In some configurations, the average representational value for a cluster is based on all data instances in the cluster; while in other configurations, the average representational value is based on a portion of the data instances sampled from the cluster (as it may be difficult to compute an average for a large number of data instances). For example, if a cluster has 100 data instances, 10 of those 100 data instances can be sampled from the cluster, and the average of the 10 data instances is used for representing the cluster.

It should be noted that using average representational values is provided by way of example only and not limitation. Other approaches for determining the distance between a given input data cluster and existing data clusters can be employed within the scope of the technology described herein. For instance, the sampling module 116 can determine the distance between clusters based on the distance between the closest data instance from each cluster (i.e., smallest minimum pairwise distance), or based on the distance between the furthest data instance from each cluster (i.e., smaller maximum pairwise distance).

After selecting a finite number of existing data clusters for a given input data cluster, the sampling module 116 samples existing data instances from the selected existing data clusters. In some aspects, the sampling module 116 selects a finite number of existing data instances from each selected existing data cluster. Limiting the selected existing data instances from each selected existing data cluster to a finite number ensures that the clustering is bounded. For instance, the sampling module 116 can select 20 existing data instances from each of the selected existing data clusters. As such, if the number of selected existing data clusters is limited to 20, and the number of existing data instances from each selected existing data cluster is limited to 20, the total number of existing data instances to use for clustering input data instances from an input data cluster is limited to 400. It should be understood that the number of existing data instances selected by the sampling module 116 for each selected existing data cluster can be configurable and can be determined based on, for instance, the overall number of the existing data instances, existing data clusters, input data instances, and/or input data clusters. The sampling module 116 can arbitrarily sample existing data instances from each selected existing data instance or can sample the existing data instances using some configurable criteria. In some instances, an equal number of data instances is sampled from each selected existing data instance.

For each input data cluster, the re-clustering module 118 forms intermediate clusters from the input data instances from a given input data cluster and the existing data instances sampled for the given input data cluster by the sampling module 116. The re-clustering module 118 can use any of a variety of different clustering algorithms. By way of example only and not limitation, the re-clustering module 118 can use HAC or mean shift clustering. The clustering algorithm can form intermediate clusters based on similarity determined between data instances. The similarity can be determined, for instance, using a distance function that indicates a distance between two data instances in a given space (e.g., a vector space). By way of example only and not limitation, similarity can be determined using Euclidian distance, cosine distance, Hamming distance, or other distance measure. Data instances that are relatively close to each other (in terms of the distance between the data instances) are more similar than data instances that are relatively far away from each other.

The clustering algorithm of the re-clustering module 118 can employ a similarity threshold when forming intermediate clusters. As noted previously, a similarity threshold used for clustering represents a lower limit of similarity between data instances for the data instances to be clustered together. In some configurations, the clustering algorithm used by the re-clustering module 118 employs the same similarity threshold as that employed by the clustering algorithm used to cluster the existing data instances in the existing data clusters of the cluster dataset 112.

The mapping module 120 maps intermediate clusters formed by the re-clustering module 118 to existing data clusters from the cluster dataset 112, where appropriate. For instance, if an intermediate cluster formed by the re-clustering module 118 is sufficiently similar to an existing data cluster, the mapping module 120 maps the intermediate cluster to the existing data cluster.

In some configurations, the mapping module 120 determines similarity between an intermediate cluster and an existing data cluster based on a distance between the two clusters and/or data instances in the two clusters. A similarity threshold based on distance can be used by the mapping module 120 to determine whether to map an intermediate cluster to an existing data cluster. In some instances, the similarity threshold used to determine whether to map an intermediate cluster to an existing data cluster is the same similarity threshold (i.e., same distance) used to cluster existing data instances into the existing data clusters in the cluster dataset 112.

In some configurations, the mapping module 120 maps an intermediate cluster to an existing data cluster based on the number or percentage of existing data instances in the intermediate cluster coming from a given existing cluster. For instance, each existing data instance can be labeled with a cluster identifier that identifies the existing data clusters from which the existing data instance was sampled. If the number or percentage of existing data instances in an intermediate cluster having a particular cluster identifier satisfies a threshold, the intermediate cluster is mapped to the existing data cluster with that particular cluster identifier. For instance, the mapping module 120 can map an intermediate cluster to an existing data cluster if a majority (e.g., over 50 percent) of the existing data instances in the intermediate cluster have the cluster identifier for that existing data cluster. Mapping an intermediate cluster to an existing data cluster can comprise, for instance, assigning each input data instance in the intermediate cluster with the cluster identifier of the existing data cluster.

The cluster addition module 122 adds new clusters to the cluster dataset 112 based on any intermediate clusters that the mapping module 120 does not map to an existing data cluster. This includes, for instance, any intermediate cluster that is not sufficiently similar to an existing data cluster. In some configurations, each intermediate cluster that is not mapped to an existing data cluster is added to the cluster dataset 112 as a new cluster. In some configurations, the cluster addition module 122 takes the input data instances from each intermediate cluster not mapped to an existing data cluster and clusters those input data instances to form new clusters, which are added to the cluster dataset 112. In such instances, the cluster addition module 122 can use any of a variety of different clustering algorithms. By way of example only and not limitation, the cluster addition module 122 can use HAC or mean shift clustering. The clustering algorithm can form new clusters based on similarity determined between data instances. The similarity can be determined, for instance, using a distance function that indicates a distance between two data instances in a given space (e.g., a vector space). By way of example only and not limitation, similarity can be determined using Euclidian distance, cosine distance, Hamming distance, or other distance measure. Data instances that are relatively close to each other (in terms of the distance between the data instances) are more similar than data instances that are relatively far away from each other.

The clustering algorithm of the cluster addition module 122 can employ a similarity threshold when forming new clusters. As noted previously, a similarity threshold used for clustering represents a lower limit of similarity between data instances for the data instances to be clustered together. In some configurations, the clustering algorithm used by the cluster addition module 122 employs the same similarity threshold as that employed by the clustering algorithm used to cluster the existing data instances in the existing data clusters of the cluster dataset 112.

The clustering system 104 can also include a user interface (UI) module 124 that provides one or more user interfaces for interacting with the clustering system 104. For instance, the UI module 124 can provide user interfaces to a user device, such as the user device 102. The user device 102 can be any type of computing device, such as, for instance, a personal computer (PC), tablet computer, desktop computer, mobile device, or any other suitable device having one or more processors. As shown in FIG. 1, the user device 102 includes an application 108 for interacting with the clustering system 104. The application 108 can be, for instance, a web browser or a dedicated application for providing functions, such as those described herein. Among other things, the application 108 can present the user interfaces provided by the UI module 112. Among other things, the user interfaces can present clusters of data instances from the cluster dataset 112. For example, in the case of the data instances being images of people's faces, a user can select a particular person, and images of that person's face returned based on images in a cluster associated with that person.

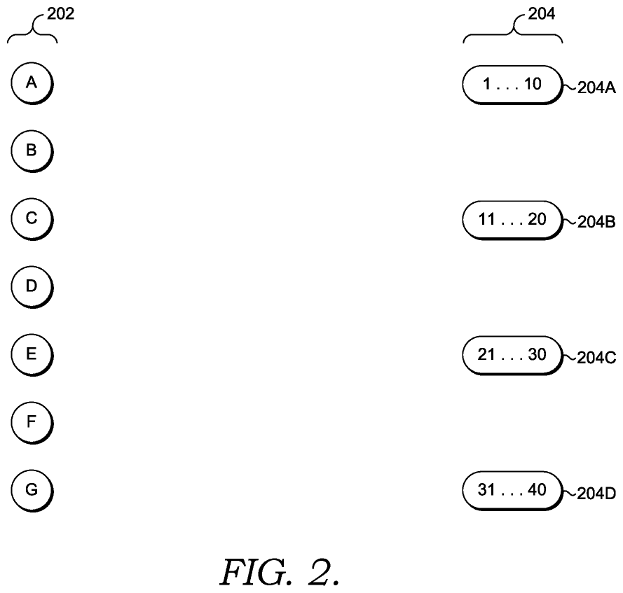

FIGS. 2-6 provide an example illustrating bounded incremental clustering in accordance with some aspects of the technology described herein. Initially, FIG. 2 shows a set of input data instances 202, including input data instances A-G that are to be clustered with a cluster dataset 204, including existing data clusters 204A, 204B, 204C, and 204D. Existing data cluster 204A includes existing data instances 1-10, existing data cluster 204B includes existing data instances 11-20, existing data cluster 204C includes existing data instances 21-30, and existing data cluster D includes existing data instances 31-40. While FIG. 2 illustrates seven input data instances to be added to a cluster dataset with four existing data clusters each having ten existing data instances, it should be understood that this is a simplified example for illustrations purposes. In practice, the technology described herein is suited to handle very large numbers of input data instances, existing data clusters, and/or existing data instances.

Each data instance of the input data instances A-G and the existing data instances 1-40 can comprise any type of classifiable data. By way of example for illustration purposes, each of the data instances could be an image of a person's face (or a representation derived from an image of a person's face). In this example, the existing data clusters 204A-204D each correspond with images of a person's face. For instance, existing data cluster 204A includes facial images of person A (i.e., existing data instances 1-10), existing data cluster 204B includes facial images of person B (i.e. existing data instances 11-20), existing data cluster 204C includes facial images of person C (i.e., existing data instances 21-30), and existing data cluster 204D includes facial images of person D (i.e., existing data instances 31-40). Input data instances A-G include new images of different people's faces that are to be clustered with the cluster dataset 204.

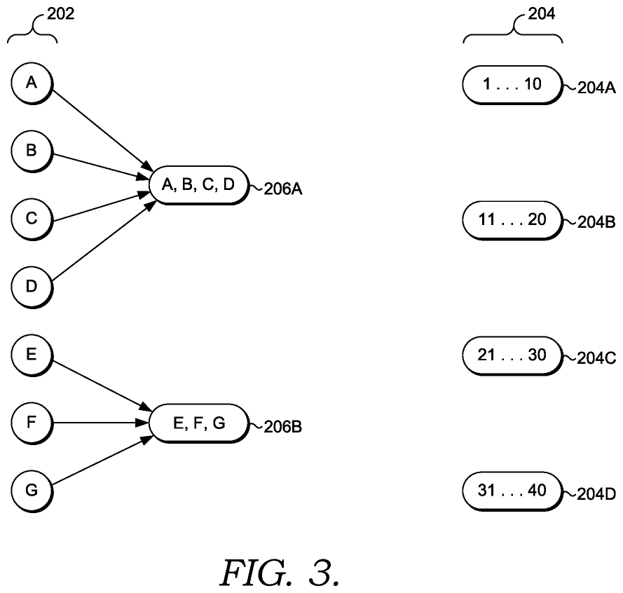

FIG. 3 shows clustering of input data instances A-G. As shown in FIG. 3, two input data clusters 206A and 206B have been formed. Input data cluster 206A includes input data instances A-D, while input data cluster 206B includes input data instances E-G. The input data clusters 206A and 206 could be generated using any of a variety of clustering algorithms, such as HAC and mean shift clustering.

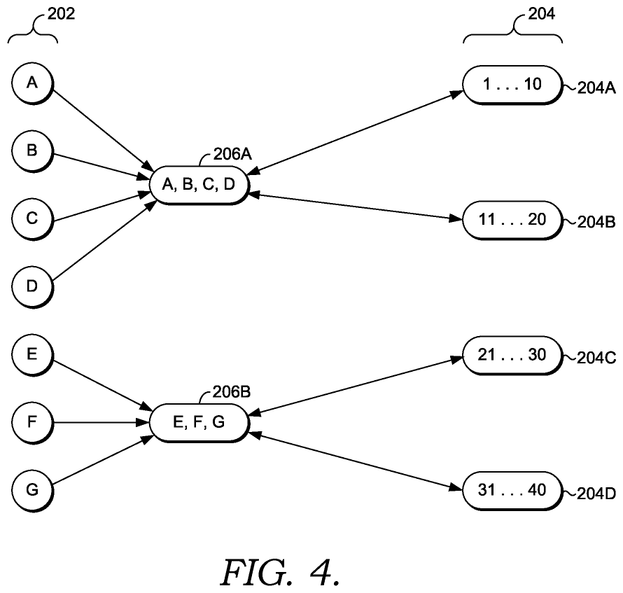

FIG. 4 shows the selection of existing data clusters for each input data cluster that has been formed. As shown in FIG. 4, existing data clusters 204A and 204B have been selected for input data cluster 206A, and existing data clusters 204C and 204D have been selected for input data cluster 206B. The existing data clusters can be selected for each input data cluster based on a similarity metric between clusters, such as a threshold distance based on an average representation value of each cluster or other metric.

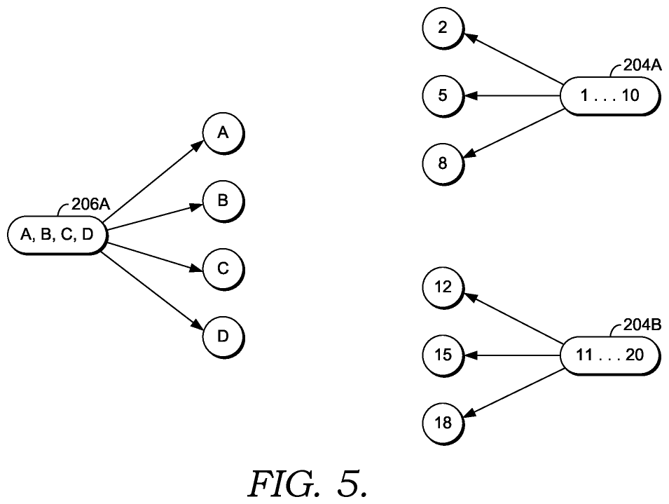

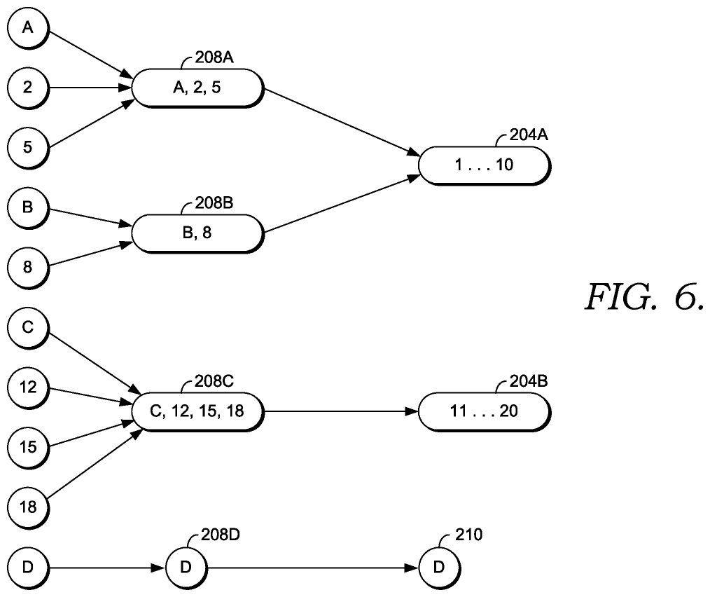

FIGS. 5 and 6 focus on the remaining process for clustering input data instances A-D from the input data cluster 206A. A similar process could be employed for input data instances E-G from the input data cluster 206B. FIG. 5 shows the sampling of existing data instances from the existing data clusters 204A and 204B selected for input data cluster 206A. In particular, existing data instances 2, 5, 8 have been selected from existing data cluster 204A, and existing data instances 12, 15, 18 have been selected from existing data cluster 204B.

FIG. 6 shows the formation of intermediate clusters from the input data clusters A-D of input data cluster 206A and the existing data clusters 2, 5, 8, 12, 15, 18 sampled from the existing data clusters 204A, 204B. As shown in FIG. 6, intermediate cluster 208A has been formed from input data instance A and existing data instances 2, 5; intermediate cluster 208B has been formed from input data instance B and existing data instance 8; intermediate cluster 208C has been formed from input data instance C and existing data instances 12, 15, 18, and intermediate cluster 208D has been formed from input data instance D. The intermediate clusters 208A-208D could be generated using any of a variety of clustering algorithms, such as HAC and mean shift clustering.

FIG. 6 also shows the mapping of intermediate clusters 208A-208D to existing data clusters 204A, 204B. As shown in FIG. 6, intermediate cluster 208A and intermediate cluster 208B have been mapped to existing data cluster 204A. In this example, input instance A and input instance B are each facial images of person A and have been mapped to the existing cluster 204A that comprises facial images of person A. Additionally, intermediate cluster 208C has been mapped to existing data cluster 204B. In this example, input instance C is a facial image of person B and has been mapped to the existing cluster 204B that comprises facial images of person B. Intermediate cluster 208C only includes input data instance D and has not been mapped to any existing data cluster. In this example, input data instance D is a facial image of a new person who has not yet been added to the cluster dataset 204. As such, a new cluster 210 with input data instance D is added to the cluster dataset 204.

### Example Methods for Bounded Incremental Clustering

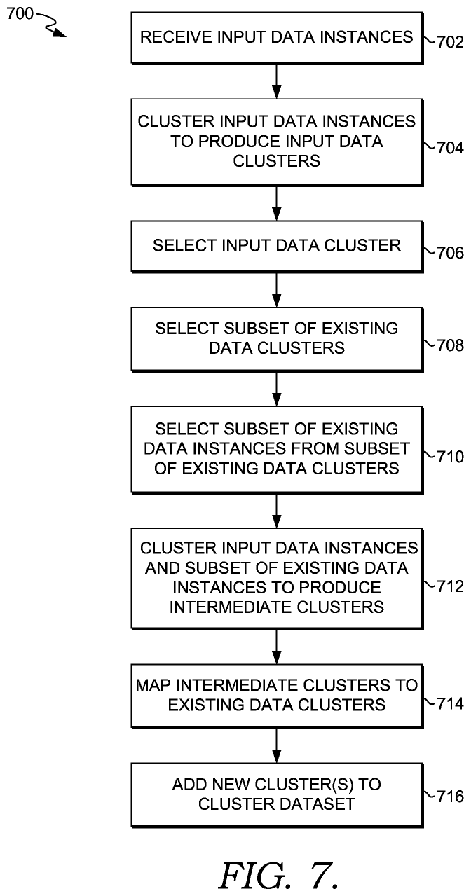

With reference now to FIG. 7, a flow diagram is provided that illustrates a method 700 for bounded incremental clustering of input data instances with existing data clusters of a cluster dataset. The method 700 can be performed, for instance, by the clustering system 104 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, input data instances are received for clustering with a cluster dataset of existing data clusters with existing data instances. Each data instance (including each input data instance from the input data instances and each existing data instance from the existing data clusters of the cluster dataset) comprises any type of data object or collection of data. For instance, each data instance can comprise image data, audio data, video data, document data, or any other type of data that can be clustered. In some cases, each data instance can be a representation of underlying data. For instance, each data instance can comprise a vector, a fingerprint, a hash, a neural network embedding, or other representation formed from underlying data, such as an image.

The input data instances are clustered to product input data clusters, as shown at block 704. Any of a variety of clustering algorithms, such as HAC or mean shift clustering, can be employed. In some configurations, the clustering algorithm used to cluster the input data instances uses a similarity threshold that can be based on a distance between input data instances. In some cases, the input data instance clustering uses a higher similarity threshold than that was used to cluster the existing data instances in the existing data clusters.

As shown at block, 706, an input data cluster is selected for further processing by blocks 708-714. It should be understood that the process of selecting and processing an input data cluster at blocks 706-714 can be performed for each input data cluster formed at block 704. The processing of the input data clusters can be performed serially or in parallel.

A subset of existing data clusters is selected from the cluster dataset for the input data cluster, as shown at block 708. In other words, a finite number of existing data clusters is selected that is less than all existing data clusters in the cluster dataset. The existing data clusters can be selected for the input data cluster in a number of different manners. Generally, the existing data clusters that are most similar to the input data cluster are selected. In some aspects, existing data clusters are selected based on a distance function that measures a distance between the input data cluster and an existing data cluster (e.g., based on average representation of data instances from each cluster, closest minimum pairwise data instances between the clusters, closest maximum pairwise data instances between the clusters, etc.).

As shown at block 710, a subset of existing data instances is selected from the subset of existing data clusters selected at block 708. The subset of existing data instances can be selected by sampling (randomly or based on some function) a finite number of existing data instances from each of the selected existing data clusters that is less than all existing data instances in each existing data cluster.

The input data instances and the subset of existing data instances selected at block 710 are clustered to produce intermediate clusters, as shown at block 712. Any of a variety of clustering algorithms, such as HAC or mean shift clustering, can be employed. In some configurations, the clustering algorithm used to form the intermediate clusters uses a similarity threshold that can be based on a distance between data instances. In some cases, the clustering algorithm used to form the intermediate clusters uses the same similarity threshold than that was used to cluster the existing data instances in the existing data clusters.

The intermediate clusters are mapped to existing data clusters, where appropriate, as shown at block 714. In some instances, an intermediate cluster is mapped to an existing data clusters based on a similarity between the intermediate cluster and the existing data cluster satisfying a threshold. In some aspects, the similarity is based on a distance function that measures a distance between an intermediate cluster and an existing data cluster (e.g., based on average representation of data instances from each cluster, closest minimum pairwise data instances between the clusters, closest maximum pairwise data instances between the clusters, etc.). In some aspects, the similarity between an intermediate cluster and an existing data cluster is based on the presence of existing data instances from the existing data cluster in the intermediate cluster. For instance, each existing data instance can be labeled with a cluster identifier identifying an existing data cluster to which it belongs. If the number or percentage of existing data instances in an intermediate cluster satisfies a threshold (e.g., a majority), the intermediate cluster is mapped to the existing data instance. Mapping an intermediate cluster to an existing data cluster can comprise storing data that correlates the intermediate cluster with the existing data cluster. In some instances, mapping an intermediate cluster to an existing data cluster can comprise labeling each input data instances from the intermediate cluster with the cluster identifier of the existing data cluster.

For any intermediate cluster that is not mapped to an existing data cluster, one or more new clusters are added to the cluster dataset, as shown at block 716. For instance, an intermediate cluster can be insufficiently similar to any existing data clusters. In some instances, the intermediate cluster is added as a new cluster to the cluster dataset. In other instances, new clusters are formed by clustering input data instances from multiple intermediate clusters not mapped to an existing data cluster, and those new clusters are added to the cluster dataset. Any of a variety of clustering algorithms, such as HAC or mean shift clustering, can be employed. In some configurations, the clustering algorithm used to form the new clusters uses a similarity threshold that can be based on a distance between data instances. In some cases, the clustering algorithm used to form the new clusters uses the same similarity threshold than that was used to cluster the existing data instances in the existing data clusters.

### Exemplary Operating Environment

Having described implementations of the present disclosure, an exemplary operating environment in which embodiments of the present technology can be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc. The I/O components 820 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 can be equipped with depth cameras, such as, stereoscopic camera systems, infrared camera systems, RGB camera systems, and combinations of these for gesture detection and recognition. Additionally, the computing device 800 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by a computing device, cause the computing device to perform operations, the operations comprising:
clustering input data instances to produce a plurality of input data clusters; and
for a first input data cluster from the plurality of input data clusters:
selecting a subset of existing data clusters from a plurality of existing data clusters from a cluster dataset, each existing data cluster including a cluster of existing data instances from a plurality of existing data instances;
selecting a subset of existing data instances from the subset of existing data clusters;
clustering the input data instances from the first input data cluster with the subset of existing data instances to produce a plurality of intermediate clusters; and
mapping a first intermediate cluster from the plurality of intermediate clusters to a first existing data cluster from the plurality of existing data clusters.

2. The computer storage media of claim 1, wherein the input data instances are clustered to produce the plurality of input data instances using a hierarchical agglomerative clustering algorithm.

3. The computer storage media of claim 1, wherein the input data instances are clustered to produce the plurality of input data clusters using a first similarity threshold that is higher than a second similarity threshold used when clustering to produce the plurality of existing data clusters.

4. The computer storage media of claim 3, wherein the input data instances from the first input data cluster and the subset of existing data instances are clustered to produce the plurality of intermediate clusters using a third similarity threshold similar to the second similarity threshold.

5. The computer storage media of claim 1, wherein selecting the subset of existing data clusters from the plurality of existing data clusters comprises:
determining a representation of the first input data cluster;
determining, for each existing data cluster, a representation of the existing data cluster; and
selecting the subset of existing data clusters from the plurality of existing based clusters based on a comparison of the representation of the first input data cluster with the representations of the existing data clusters.

6. The computer storage media of claim 1, wherein mapping the first intermediate cluster from the plurality of intermediate clusters to the first existing data cluster from the plurality of data clusters is based on determining the first intermediate cluster includes a threshold number of existing data instances from the first existing data cluster.

7. The computer storage media of claim 1, wherein the operations further comprise:
generating a new cluster with one or more data instances from at least a second input data cluster; and
adding the new cluster to the cluster dataset.

8. The computer storage media of claim 1, wherein each input data instance comprises a vector representation of underlying data.

9. A computer-implemented method comprising:
forming one or more input data clusters from a plurality of input data instances; and
for each input data cluster:
selecting one or more existing data clusters from a plurality of existing data clusters;
selecting one or more existing data instances from the selected one or more existing data instances;
forming one or more intermediate clusters from input data instances in the input data cluster and the selected one or more existing data instances; and
mapping at least one of the one or more intermediate clusters to one of the plurality of existing data clusters.

10. The method of claim 9, wherein the one or more input data clusters are formed using a first similarity threshold that is higher than a second similarity threshold used when forming the plurality of existing data clusters.

11. The method of claim 10, wherein the one or more intermediate clusters are formed using a third similarity threshold similar to the second similarity threshold.

12. The method of claim 10, wherein selecting the one or more existing data clusters from the plurality of existing data clusters comprises:
determining a representation of the input data cluster;
determining, for each existing data cluster, a representation of the existing data cluster; and
selecting the one or more existing data clusters from the plurality of existing based clusters based on a comparison of the representation of the input data cluster with the representations of the existing data clusters.

13. The method of claim 10, wherein mapping at least one of the one or more intermediate clusters to one of the plurality of existing data clusters comprises mapping a first intermediate cluster to a first existing data cluster based on a distance between the first intermediate cluster and the first existing data cluster.

14. The method of claim 10, wherein the method further comprises:
generating a new cluster with one or more input data instances; and
adding the new cluster to a cluster dataset comprising the plurality of existing data clusters.

15. A computer system comprising:
a processor; and
a computer storage medium storing computer-useable instructions that, when used by the processor, causes the computer system to perform operations comprising:
receiving a plurality of input data instances;
generating a plurality of input data clusters from the input data instances; and
mapping a first input data instance from a first input data cluster to a first existing data cluster from a plurality of existing data clusters by:
selecting a subset of existing data clusters comprising less than all of the existing data clusters;
selecting a subset of existing data instances from the subset of existing data clusters, the subset of existing instances comprising less than all the existing data instances from the subset of existing data clusters;
generating an intermediate cluster from at least a portion of the selected subset of existing data instance and at least a portion of the input data instances from the first input data cluster including the first input data instance; and
mapping the intermediate cluster including the first input data instance to the first existing data cluster.

16. The system of claim 15, wherein the plurality of input data clusters are generated using a first similarity threshold that is higher than a second similarity threshold used when generating the plurality of existing data clusters.

17. The system of claim 15, wherein the intermediate cluster is formed using a third similarity threshold similar to the second similarity threshold.

18. The system of claim 15, wherein selecting the subset of existing data clusters comprises:
determining a representation of the first input data cluster;
determining, for each existing data cluster from the subset of existing clusters, a representation of the existing data cluster; and
selecting the subset of existing data clusters based on a comparison of the representation of the first input data cluster with the representations of the existing data clusters.

19. The system of claim 15, wherein mapping the intermediate cluster including the first input data instance to the first existing data cluster comprises mapping the intermediate cluster to the first existing data cluster based on a similarity of the intermediate cluster to the first existing data cluster.

20. The system of claim 15, wherein the operations further comprise:
generating a new cluster with one or more input data instances; and
adding the new cluster to a cluster dataset comprising the plurality of existing data clusters.
